(19) United States
(12) Patent Application Publication
(10) Pub. No.: US 2003/0003953 A1
(43) Pub. Date: Jan. 2, 2003

(54) Multi-user chat service in a cellular network

(75) Inventor: Jean-Francois Houplain, Boulogne (FR)

Correspondence Address: SUGHRUE, MION, ZINN, MACPEAK & SEAS, PLLC, 2100 Pennsylvania Avenue, NW, Washington, DC, 20037-3213, US

(73) Assignee: COMVERSE NETWORK SYSTEMS LTD.

(21) Appl. No.: 09/881,845

(22) Filed: Jun. 18, 2001

(51) Int. Cl. H04M 1/00

(52) U.S. Cl. 455/553; 455/520

(57) ABSTRACT

A system and a method for supporting a multi-user text chat service in a mobile network uses existing standards and products while providing efficient use of radio frequency and signaling resources. The system includes a computing element for converting messages between two known formats and which further provides security, billing and other administrative functions. The system is thus able to combine a point-to-point messaging protocol for originating a message and a broadcast protocol for receiving the message.

### FIELD OF INVENTION

The present invention relates to a mobile cellular network that is capable of supporting an interactive chat room among multiple subscribers. In particular, a subscriber to a cellular phone network is able to send a message using text, audio or video to several other subscribers in the cellular network who are members of a chat room. The invention reuses existing standard communication protocols in a manner to efficiently use signaling channels and the radio resources of an existing cellular network.

### BACKGROUND OF THE INVENTION

A conventionally known cellular network is the Global System for Mobile Communications (GSM). Short message services, which are supported in many cellular systems, permit transfer of messages between the originating source and one or more subscribers in the network. The GSM standards specify two forms of a short message service (SMS) between users.

The first SMS service comprises a point-to-point messaging service whereby one subscriber can create and send a text message to one other subscriber in the cellular network. In GSM, the short text message may include up to 160 characters, though other cellular systems can support messages of longer lengths. This point-to-point message service uses the Mobile Originated SMS (“MO-SMS”) protocol to transmit the message from the mobile originator to a short message service center (SMS C). At the transport layer, MO-SMS uses a TPDU (transfer protocol data unit) known as SMS-SUBMIT to transfer messages from the mobile to the SMSC. The SMSC, in turn, transmits the message to the addressee-subscriber using the Mobile Terminated SMS (“MT-SMS”) protocol. MT-SMS uses a TPDU known as SMS-DELIVER to transfer messages from the SMSC to the mobile. SMS-SUBMIT and SMS-DELIVER are supported by respective lower level relay protocol data units in the GSM protocol stack. The protocol layers include addresses for the source and destination devices.

A conventional method to provide the multi-user chat facility consumes significant radio and signaling resources. This is due to the fact that upon receipt of the MO-SMS message, a standard MT-SMS message must be sent from the SMSC to every subscriber participating in the chat room. In particular, a central network database facility maintains a list of users in a chat room and associated phone numbers. The message content contained in the originator's MO-SMS is then sent via individual MT-SMS messages to every telephone number for each participant of the chat room. Thus, if fifty cellular phone subscribers participate in a “chat” room, and one subscriber originates message “A” (using MO-SMS), then the chat room application resources must create fifty individual MT-SMS messages to transmit message “A” to all chat participants. This consumes significant signaling and radio resources for the substantive message information in the message. Moreover, because MT-SMS includes a return acknowledgement, this consumes additional signaling and radio resources. Most implementations of mobile instant messaging service use the inefficient technique described above.

The second short messaging service available in GSM comprises a broadcast service using the cell broadcast (CELL-B) protocol. The cell broadcast protocol of GSM nominally transmits messages of up to 93 characters. Other standards support messages of various maximum lengths. In this messaging service, short messages are sent in broadcast mode. Typical content would include weather information, stock quotes, sports scores, etc., which is broadcast to several subscribers in one or more designated cells. One CELL-B message containing a particular stock quote or sports score, etc. is created and broadcast using a CELL-B logical channel. The short messages are broadcast over logical channels provisioned by a subscriber. Therefore, a user can define a specific logical channel to receive broadcast information of interest to the subscriber. No acknowledgment is sent in the CELL-B protocol. Because the data packet is sent as a broadcast message and not point-to-point, CELL-B messages are not interactive and thus CELL-B does not support an interactive chat service.

The first SMS service permits a subscriber to send only individual messages to other individual “chat” users in the network. Thus, the first SMS service uses GSM resources in a highly inefficient manner when several users participate in a chat room. The second SMS service only permits a one-way transmission between a server and certain subscribers in a predetermined area. Neither existing GSM message service permits a subscriber to send messages to multiple subscribers and to receive messages from multiple subscribers in an interactive “chat” room environment in an efficient manner. Applicant's invention overcomes the above deficiencies of existing short messaging services to provide a new type of cellular service.

### SUMMARY OF THE INVENTION

The present invention combines a known broadcast protocol with features of a known point-to-point protocol to provide a cellular chat service using standard communication facilities. A preferred embodiment is described with reference to protocols used in GSM, though the invention is not limited to this standard. According to the preferred embodiment, the MO-SMS protocol is used in conjunction with the CELL-B protocol in order to provide a multi-user text chat messaging service. In particular, an individual subscriber participating in a chat room sends a text message in the MO-SMS protocol to a specific ISDN number, which can be an MS-ISDN, corresponding to a chat room to which the user has subscribed. A Short Message Service Center (SMSC) receives the message. Once received by the SMSC, the user data, such as a text message data, contained in the originating MO-SMS message is extracted and forwarded to the Cell Broadcast Center (CBC) via a computing element (CE). It is noted that the MSISDN is analogous to any ISDN number used in a standard wire-based communication network, in that the MSISDN provides a unique identifier for a particular chat room. More specifically, a “sports chat room” would be assigned MSISDN₁ and an “investor's chat room” would be assigned MSISDN₂. The computing element (CE) converts the text message extracted from the MO-SMS communication which is received at the SMSC and repackages the message in a format suitable for formation in a CELL-B message for simultaneous distribution to multiple users participating in the chat room. The CE can be disposed so that it extracts necessary information from the SMS-DELIVER TPDU and its lower level supporting layers. Each individual authorized to participate in the chat room can receive the message and can further respond to other “chat” participants using the MO-SMS and CELL-B protocols as described above.

### DESCRIPTION OF THE DRAWINGS

A preferred embodiment of the present invention will be described below with reference to the drawings, where

FIG. 1 illustrates a system supporting a cellular chat service according to a preferred embodiment of the invention;

FIG. 2 illustrates a computing element of a preferred embodiment; and

FIG. 3 is a flowchart of operations for implementing a cellular chat service according to the preferred embodiment.

### DESCRIPTION OF PREFERRED EMBODIMENT

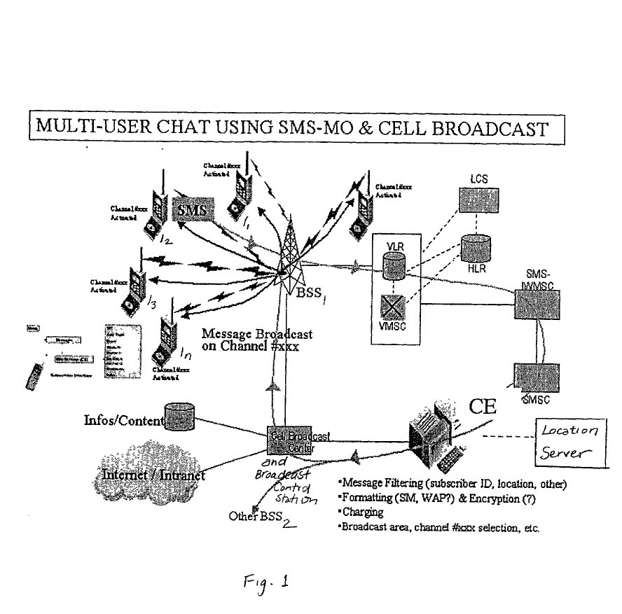

Referring to FIG. 1, a plurality of mobile station subscribers 1₁ to 1ₙ are affiliated with a base station subsystem BSS1. Using GSM's MO-SMS protocol and the SMS-SUBMIT TPDU, a subscriber 1₁ transmits a text message designated for a particular MSISDN, which corresponds to a chat room. The destination address is specified both as an element of the SMS-SUBMIT TPDU in the transfer layer and also as an element in the underlying relay layer. In the relay layer, the destination address is designated in the RP-MO-DATA type data unit. Known processing elements in GSM, such as the VLR (visitor's location register), HLR (home location register), SMS-IWSMC (short messaging service internetworking service center), and SMSC (short message service center) involved in the transmission are not critical to the invention and thus will not be described in detail. Relevant functions of these elements will be explained as necessary.

A computing element CE, which is not part of a standard GSM network, extracts the user data and reformats the extracted data for use in a CELL-B packet for transmission to multiple receiving mobile subscribers, e.g. 1₁ to 1ₙ. In addition to packet reformatting, the -=15 computing element performs message filtering and authorization. As an example of authorization processing, the computing element can check the MSISDN of the originating terminal, which is included in the originator's packet, to determine whether the originating terminal is permitted to send a message using the particular chat service. If the originating terminal is not included in a database of authorized chat participants, then the CE can preclude that message from being transmitted. As an example of message filtering, the computing element determines where the originator's message should be broadcast based on the chat channel selected by the sender, user profile (which can be derived by the originating MSISDN) and other criteria. Based on information determined by the computing element, the CELL-B message may be sent via the cell broadcast center (CBC) to those terminals affiliated with BSS1 or to mobile stations of another cell affiliated with BSS2 or to all terminals. The primary requirement for receipt of the CELL-B message by a mobile station is that the station be provisioned to receive the logical channel for a chat room. Provisioning of a logical channel is a standard feature of most GSM phones presently in use and is described in the user's literature for the phone. The CE can also generate data for external billing of the transmission and generate data packets to be sent via existing external devices, which will be described in more detail below.

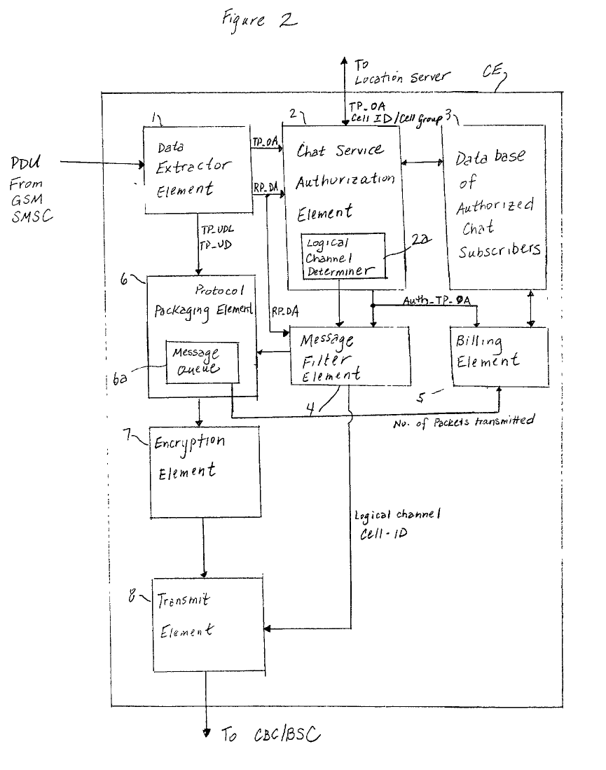

The components of the CE are shown in FIG. 2. At data extractor element 1, the CE receives the packet data unit (PDU) that would be affiliated with a standard SMS transmission frame. As one example, a mobile station would normally receive a short message via the transfer protocol data unit SMS-DELIVER, which includes the following fields:

TABLE A

| Abbr. | Reference | Description |
|---|---|---|
| TP-MTI | TP-Message-Type- | Parameter describing the message |
| | Indicator | type. |
| TP-MMS | TP-More-Messages-to- | Parameter indicating whether or not |
| | Send | there are more messages to send. |
| TP-RP | TP-Reply-Path | Parameter indicating that Reply Path |
| | | exists. |
| TP-UDHI | TP-User-Data-Header- | Parameter indicating that the TP-UD |
| | Indicator | field contains a Header. |
| TP-SRI | TP-Status-Report- | Parameter indicating if the SME has |
| | Indication | requested a status report. |
| TP-OA | TP-Originating- | Address of the originating SME. |
| | Address | |
| TP-PID | TP-Protocol- | Parameter identifying the above layer |
| | Identifier | protocol, if any. |
| TP-DCS | TP-Data-Coding- | Parameter identifying the coding |
| | Scheme | scheme within the TP-User-Data. |
| TP-SCTS | TP-Service-Centre- | Parameter identifying time when the |
| | Time-Stamp | SC received the message. |
| TP-UDL | TP-User-Data- | Parameter indicating the length of the |
| | Length | TP-User-Data field to follow. |
| TP-UD | TP-User-Data | |

The computing element may use any one of four options for directing the message contents contained in an SMS_DELIVER packet data unit to an appropriate logical channel, which is received on handsets which are provisioned by the user to receive the logical channel. As discussed above, procedures for provisioning are provided in the user's literature for commonly used GSM phones. As a first option, the originating mobile may send a short message to a particular MSISDN that the CE designates as corresponding to a logical channel for a specific chat room. This case implements a direct mapping between the destination MSISDN, or other identifying information, to a logical channel for a chat room for broadcast purposes. The destination address is obtained in a Relay layer of an SMS packet, (RP-DA), as shown in Table B. As a second option, the computing element extracts the source ISDN or other identifying information, from the lower layers of the submitted SMS packet. The source ISDN may be mapped to the logical channels (corresponding to chat rooms) that the source is authorized to participate in. Additionally, the correct cell ID for the broadcast packet can be derived by determining the originating subscriber's ISDN and querying the location server. The location server will be able to determine the geographic location of the originator and thus can determine the region where packets should be broadcast. This region corresponds to one or more subcells in a geographic region or all cells in a network. A logical channel may have restrictions based on geographic area. The chat room service provider can place limitations on how a logical channel is used in different geographic areas. These restrictions can be based on whether a chat subject would have only local interest or a more general interest that spans a wider area. If multiple chat rooms are designated by a single ISDN, then the CE can further determine the logical channel on which the packet should be broadcast based on a user profile associated with the originator's identifying information. The third option comprises a combination of the first and second options described above. In particular, both the source ISDN and the destination MSISDN are used to determine the logical channel and the cell ID for the broadcast packet. As a fourth option, in conjunction with any of the above options, the message body can be used to determine a logical channel by using a number or letter appearing in a particular location of the message. For example, an “F” in the first space of the TP-UD field can specify a “football” chat room, and a “G” in the same space can specify a “golf” chat room.

In implementing the chat service, most of the fields associated with the SMS-DELIVER packet need not be maintained since transmission will occur using a broadcast protocol. For example, the TR-RP reply path would not be implemented because no return message or acknowledgment is expected on the same channel. The time stamp data also would not be used in the chat service. Therefore, once the packet is received in the CE, the CE is free to disregard these data bits of the SMS-DELIVER packet.

By contrast, the CE uses the TP-OA field to determine the originating address of the SME (short messaging entity), such as a mobile terminal. The TP-OA can correspond to an MSISDN. The CE can use the identifying information for several functions. For instance, a chat service authorization element 2 uses the TP-OA to determine authorization status for the originating mobile to participate in a particular chat room. TP-OA would be compared with contents of an authorization database 3 for different chat services. The database may be dedicated for the chat service or shared with other GSM applications or can be centralized. In the event of a centralized database system, the CE would need to implement a protocol, such as LDAP (lightweight directory application protocol) to access the centralized database. That connection is not shown here. The chat service authorization element may also transfer the extracted TP_OA to a location server to determine in which cell the originating subscriber is located. The location server has the ability to query a database, for example, about the current location of an originating mobile terminal based on the MS-ISDN of the mobile. The current location provides corresponding cell ID information, so that it can be determined where the chat message should be broadcast. The location server may receive inquiries and provide responses to external entities. The logical channel determiner 2a can be used to process the destination and/or origination address information to provide a logical channel determination. The determination of the logical channel is discussed above. If the logical channel is designated as an MSISDN, then the logical channel can be pre-programmed into a user's “personal phone book” if the mobile terminal supports this “personal phone book” feature. Though the logical channel determiner 2a is shown as part of the chat service authorization element, it may be constructed as a separate processing component. Once the authorization element 2 confirms that the originating mobile is permitted to participate in a chat room, the authorized signal TP-OA (Aut-TP-OA) can be used to filter messages according to 1) the geographic source of the message and/or the destination of the message or 2) the user profile affiliated with the TP_OA in a message filter element 4. The destination address for a chat room is specified in the relay layer protocol data unit RP-MT-DATA. The fields of this PDU are shown below.

TABLE B

| Abbr. | Reference | Description |
|---|---|---|
| RP-PRI | RP-Priority | Parameter indicating whether or not the short |
| | Request | message transfer should be stopped if the |
| | | originator SC (service center) address is |
| | | already contained in the MWD (Messages- |
| | | Waiting-Data). |
| RP-MMS | RP-More- | Parameter indicating that there are more |
| | Messages-To- | messages waiting in the SC. |
| | Send | |
| RP-OA | RP- | Address of the originating SC. |
| | Originating- | |
| | Address | |
| RIP-DA | RP- | Address of the destination MS (Mobile |
| | Destination- | Station). |
| | Address | |
| RIP-UD | RP-User-Data | Parameter containing the TPDU. |
| RIP-MTI | RIP-Message | Parameter indicating if the TPDU is a SMS |
| | Type Indicator | Deliver or a SMS Status Report. |
| RP-SMEA | RP-Originating | Address of the originating SME. |
| | SME-Address | |

The element RP-DA specifies the destination. The authorization element 2 includes a logical channel determiner 2a. Based on the RP-DA, the logical channel for broadcasts can be determined by the channel determiner 2a. The logical channel determiner may also provide the correct logical channel based on a table associated with the origination address information. A filtering element 4 receives Aut-TP-OA from the authorization element 2 and RP-DA from the data extractor 1. As a first example of message filtering, a chat subscriber in region A who is participating in a “sports” chat room may not have his message broadcast to a chat subscriber in region B, where there would be little mutual interest in comments between the subscribers in two regions A and B. In this connection, the chat service authorization element sends the originating address to a location server. The location server returns the cell ID to indicate the geographic area (cells) over which the chat message is broadcast. Other types of message filtering may also be applied using TP-OA, and RP-DA. As a second example, the TP_OA may be associated with a user profile stored in a database 3. The message filter 4 can transmit the contents of the MO-SMS on a particular logical channel based on the user profile. As a further feature of message filtering, the filter element 4 can also examine the contents of the message TP-UD and provide filtering based on substantive information contained in the message contents to determine a logical channel or a cell ID.

A billing element 5 receives the authorized origination address Aut-TP-OA to accumulate billing information specifically for the chat service. The data extractor 1 also extracts the TP-UDL (user data length) information. A protocol packaging element 6 uses the TP-UDL to determine whether concatenation of outgoing CELL-B packets will be necessary. In particular, because the point-to-point short messaging service (SMS) protocols support different message lengths than CELL-B, the message in the point-to-point SMS protocol may require repackaging in two or more concatenated CELL-B packets. As an alternative, the packing element may determine the user data length in the TP-UD element, rather than relying on TP-UDL. One or more reformatted intermediate packets may be stored in a message queue 6a prior to transmission.

An encryption element 7 (optional) receives the reformatted packets that are used by CBC/BSC to create one or more CELL-B packets and provides encryption to avoid eavesdropping on a chat room by unauthorized cellular subscribers. The encryption provided at the computing element can be coordinated with the processor and memory resources available in the SIM (subscriber identity module) Toolkit, to take advantages of the SIM card processing capabilities for decryption present in each mobile in a GSM system. The transmit element 8 forwards the repackaged data to the cell broadcast center and base station control for transmission to the subscribers whose terminals are provisioned to receive the chat room messages as a CELL-B message.

While the above CE functions have been described with respect to fields of the SMS-DELIVER protocol data unit and the supporting RP-MT-DATA unit, the CE can also obtain the destination address (TP-DA), origination address (RP-OA), user data length (TP-LDL), and user data (TP-UD) from the SMS-SUBMIT protocol data unit and underlying support relay layer protocol data unit PR-MO-DATA. The CE will receive and process the SMS-DELIVER protocol data unit and supporting PR-MT-DATA.

Once the SMS-DELIVER packet has been processed by the authorization element 2, the filter element 4, and the billing element 5, the packaging element 6 must place the extracted UD in a format suitable for CELL-B. GSM does not mandate a communications protocol for several communications links in the CELL-B service. Conventionally, the cell broadcast entity (CBE) information provider is free to coordinate with the cellular service provider regarding the CBE to cell broadcast center (CBC) interface. The cell broadcast center (CBC) interfaces with a single base station controller (BSC) to provide packet broadcasts to mobile stations via a base station (BTS or BSS). A single BSC may control one or more BSSs. The exact construction of a CELL-B protocol between the BSC and the BTS also is not mandated. An exemplary communication protocol used for this communication link is X.25.

Though no protocol for CBC-BSC is mandated, the GSM standards do set forth an exemplary protocol stack to be used in CBC-BSC communications, which preferably comprises an OSI stack or equivalent. More precise details of the CBC-BSC stack can be found in GSM 03.49, which is incorporated by reference. The nature of the implementation is not critical to the invention.

The CE of the present invention reformats the short messaging protocol for point to point communications (e.g. SMS-DELIVER) to an appropriate CELL-B format. The CE, at a 0 minimum, formats the CELL-B message and splits the CELL-B message into an appropriate number of pages, as necessary. If a CELL B message is short enough, then a single page should be sufficient to transmit the message, and therefore splitting into multiple pages is not required. The CE also takes into account CELL-B communications according to suggested GSM standards 03.49 and which utilize the primitives for CBC to BSC communication as shown in the following table.

TABLE C

| Parameters | Description |
|---|---|
| Message- | Identifies source/type of message. |
| Identifier | |
| New-Serial- | This enables message change to be indicated since it is |
| Number | altered every time the message is changed. This serial |
| | number identifies a particular message, which may be |
| | several pages in length, from the source indicated by |
| | the message identifier. |
| Number-of-Pages | Enables the number of pages in the message to be |
| | indicated. |
| Cell-List | This identifies the cells to which the primitives apply. |
| | The cell-list contains the following information, as |
| | described in GSM 08.08, section 3.2.2.27. |
| | Cell identification discriminator |
| | Cell identity 1 |
| | Cell identity N |
| Repetition-Rate | This indicates the frequency at which broadcast of the |
| | message should be repeated. The maximum frequency |
| | with which a message may be broadcast over the air |
| | interface is one 8 × 51 multiframe sequence which |
| | corresponds to a period of approximately 1.883 |
| | seconds. The value of ‘Repetition-Rate’ shall be in the |
| | range 1 to 1024 where each unit will represent one 8 × |
| | 51 multiframe sequence. |
| | In the event of a conflict where the BSS has more than |
| | one message to send at the same time, the BSC shall |
| | decide the order of such messages as an |
| | implementation matter. |
| No-of- | This specifies the number of times the message is to |
| Broadcasts- | be broadcast. The parameter may take any value up to |
| Requested | 2880 (this maximum allows the message to be |
| | broadcast every 30 seconds for 24 hours). If the |
| | parameter is set to 0 then the message will be |
| | broadcast indefinitely (i.e. until the BSC receives an |
| | appropriate Kill-Message Request/Indication |
| | primitive). |
| No-of- | This parameter is a list indicating the number of times |
| Broadcasts- | that the message (i.e. all pages of the message) has |
| Completed-List | been sent to each Cell in the Cell-List for broadcast |
| | over the air interface. |
| Cell-Identity | Identity of cell. |
| Failure-List | This identifies the list of cells which the BSC could |
| | not complete the request. The failure cause for each |
| | cell is indicated. |
| CBCH-Loading | A list of the predicted short term load of each cell on |
| List¹ | the list expressed in a percentage. The calculation of |
| | this percentage is an implementation matter. |
| Data Coding | Identifies alphabet or coding employed for the |
| Scheme | message characters. |
| CBS-Message²- | This carries 82 octets of CBS information. |
| Information- | |
| Page n | |
| CBS-Message- | Gives the number of octets of the CBS-Message- |
| Information- | Information-Page n containing cell broadcast |
| Length n | information. The remaining octets of the CBS- |
| | Message-Information-Page n only contain padding |
| | information. |

1. CBCH Cell Broadcast Channel
2. CBS = Cell Broadcast Service

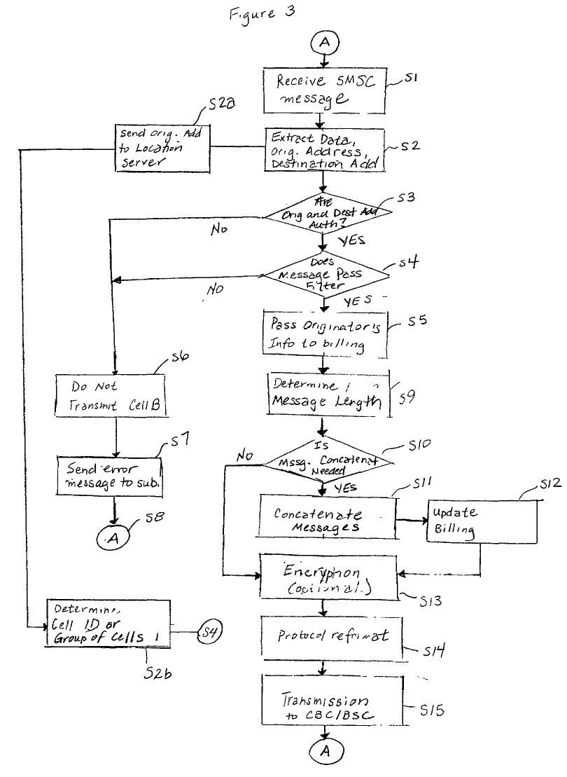

The computing element has been described in general functional terms. The operations performed according to the present invention are explained with reference to FIG. 3. The CE receives the standard GSM protocol data unit, such as SMS-DELIVER, at S1.

The CE extracts TP-OA, TP-UD, TP-UDL, and TP-DA (or RP-DA) at S2. At S2a, the origination address is delivered to a location server. The location server can determine and return the cell ID for a broadcast at S2b. Back at S2, the extracted TP-OA is used by an authorization element to determine whether the originating mobile station is authorized to participate in the chat room at S3. This can be achieved by comparing the identification information of the RP-OA with a database of authorized chat subscribers. The RP-DA (destination address) is also verified to correspond to a chat room at S3. As discussed above, a chat room corresponds to a logical channel to which one or more subscribers send short messages. If the TP-OA exists in an authorized database of chat users, and RP-DA (which may take on the form of MSISDN) corresponds to a chat room, the authorization element supplies an Auth-TP-OA signal to a message filter element. The message filter element determines whether the message will be broadcast to one or more cells based on the result of S2b and logical channels based on the destination address or originator's user profile at S4.

As previously discussed, one of four options may be used to determine the logical channel for the broadcast packet. The destination MS-ISDN may be directly mapped to a logical channel, a user profile database may be queried to determine the logical channel, a special character in the message field may indicate the logical channel or a combination of these features may be used. The computing element may broadcast the packet to one or more cells, but nominally, the packet would be broadcast to the cell where the originating terminal is located based on the cell ID returned in S2b. The computing element may determine that the message should be broadcast to several cells, such as the cell returned by the location server and one or more cells, or to all cells.

If the output of the message filter element 4 indicates that the message will not be broadcast, no CELLB packet is transmitted (S6). A notification message may optionally be sent to the originating mobile station at S7, and CE processing continues for a next GSM protocol unit as above (S8). If the user and destination are authorized (S3 produces result “Yes”) and passes through the message filter (S4 produces result “Yes”), the authorized TP-OA is passed to a billing element to accumulate charges for the particular originating station at S5.

The length of the user data, corresponding to the substantive message data, is determined at S9. This may be determined by counting the number of characters in the TP_UD field or by the data element TP_UDL. At S10, a determination is made as to whether the message data must be delivered in two or more reformatted packets and concatenated. If the message data exceeds a particular length, then concatenation is required. In GSM, the predetermined length is the upper limit of character text that can be accommodated in CELLB. The concatenation formatting occurs in S11, and additional resources for billing purposes is noted in S12. At S13, the message data (e.g. message payload) is optionally encrypted. In a conventional CELL-B communication, each mobile station may receive any cell broadcast logical channel, as long as that mobile station is provisioned to receive that logical channel. In the present embodiment, one or more cell broadcast logical channels may be assigned to a chat room. Because a mobile station can receive a cell broadcast logical channel as long as it is provisioned, this permits eavesdropping through mobile stations which are not authorized to participate in the chat service. To obviate this, the CE can include an encryption code prior to transmitting the CELL-B packet as part of a chat service. Only authorized mobile stations would be able to decode the encrypted message.

Modified forms of known encryption protocols can be used to provide a measure of controlled access to a chat room. One conventional method, Public Key cryptography employs a two key system wherein the two keys are asymmetric. However, even though the two keys are different, they are a set and work together to encode and decode information. One key is kept private, or secret, by one of the parties and the other key is made public. When a public key is used to encrypt a message, only the private key from the pair is capable of decrypting the message. Thus, in conventional public key cryptography, anyone can send secret messages to the holder of a private key because the matching public key is readily available, yet no one other than the intended recipient, who possesses the matching private key, can decrypt the message. For the present invention, to take advantage of the broadcast aspect of CELL-B, the “private” key for decrypting messages for a certain chat room is shared among multiple handset users. The standard private key serves as a “semi-private” key in the context of this invention. The user can obtain the key by programming the key into the SIM of the mobile handset or via an over the air transmission upon enrollment in a chat room. As an alternative to asymmetric key cryptography, symmetric key cryptography may also be used. In GSM, decryption at the mobile may be supplied by the processing resources that are part of the SIM Toolkit.

At S14, the CE formats the packet in a manner suitable for conversion to a CELL-B packet. At S14, the CE adds information as to which of the cells and logical channel(s) associated with a cell broadcast station will transmit the reformatted CELL-B packet. This can be based on message filtering of S4 or the destination addresses of the message. The CE may further determine whether one or more base stations (e.g. BSS1 and/or BSS2) will transmit the reformatted CELL-B packet.

Transmission to a CBC/BSC for transmission of a CELL-B packet occurs at S15, and the CE processing continues as outlined above for a next GSM packet.

The functions of the CE described with respect to FIGS. 2 and 3 may be implemented by software, hardware or a combination of the two.

Since the data format of incoming messages and outgoing messages of the preferred embodiment are known, one skilled in the art would understand the programming details necessary to convert the protocols. In particular, the data formatting provided by the packaging element 6 includes removal of remaining framing bits of the low level protocol layers affiliated with SMS-DELIVER to access the user data, and adding bits suitable for interfacing with the CBC/BSC interface. The message queuing function is also within the capability of one skilled in the art, such that a detailed description of the program is not necessary. Similarly, since the known protocol formats include the data fields necessary to perform the billing and security functions, such as MSISDN information, one skilled in the art would also be able to construct the software or software/hardware combination necessary to extract the identifying information and accumulate database information for billing and authentication purposes.

Based on the above operations, every subscriber participating in a chat room can send (with MO-SMS) and receive (with cell broadcast) every message sent by any other participant in the chat. This enables a chat service to be implemented over a mobile network, while conserving major quantities of airtime and other network resources. In order for a subscriber to receive chat messages, the subscriber must provision his handset to a particular CELL-B logical channel for the chat room. Each mobile user can participate in multiple chat rooms, provided his handset can accommodate receipt of the associated CELL-B logical channels.

The present invention reuses existing products and standards. Accordingly, no modification of existing infrastructure of signaling or radio resources is required, and in fact the invention allows the provision of more services with a lower consumption of network resources. The invention therefore permits widespread scalability and a cost-effective system. Because no acknowledgments are required for CELL-B transmission and only one message needs to be transmitted by each BSS, radio and signaling resources are efficiently used. As an additional benefit, the use of CELL-B in lieu of MT-SMS reduces the risk of overloading the memory card in a mobile station.

While a preferred embodiment of the invention has been discussed above in connection with the GSM standard, one skilled in the art would understand that changes can be made thereto without departing from the spirit and the scope of the present invention. In particular, though the system is described as being implemented in GSM, with its attendant protocols, the present invention is applicable to any standard that supports an independent point-to-point short messaging service and an independent broadcast short message service. For example, the invention may also be applied in future generation GSM systems and third generation mobile systems (3G), such as Universal Mobile Telecommunications Systems (UMTS) and IMT 2000. Additionally, while the preferred embodiment discusses message transmission in the context of text messages, other types of data such as audio, video and messages may also be transmitted. One skilled in the art would be able to practice the invention for different media.

What is claimed is:

1. A cellular communication system operable to support a multi-user messaging service comprising:
a mobile subscriber unit operable to originate a message using a format of a first standard protocol; and
a computing element to reformat the message received from the subscriber unit transmitted in the first standard protocol to a format of a second standard protocol, said second standard protocol comprising a broadcast protocol

2. The system of claim 1, further comprising a location server and wherein the computing element determines one or more cells for broadcast using said second standard protocol based on a location result of the mobile subscriber unit which originates a message, said location result being provided by the location server.

3. The system of claim 2, wherein the second standard protocol comprises delivery of unacknowledged data packets over a logical channel in broadcast mode.

4. The system of claim 1, wherein the computing element extracts message data from the message and a source address and a destination address of the message of the first standard protocol and adds reformatting information to the message data according to the second standard protocol.

5. The system of claim 4, wherein the computing element determines a length of the message data and creates at least first and second messages in the second standard protocol when the length of the message data exceeds a predetermined length, each of the first and second messages in the second standard protocol conveying a portion of the message data.

6. The system of claim 5, wherein the computing element extracts a data length indicator to determine the length of the message data.

7. The system of claim 6, wherein the first standard protocol comprises MO-SMS in a GSM system, and wherein the second standard protocol comprises cell broadcast CELL-B in the GSM system.

8. The system of claim 1, wherein the computing element determines one or more logical channels based on at least one of a source address and a destination address of a message received from one of said plurality of subscriber units, and the reformatted message is sent over the determined logical channels.

9. The system of claim 1, wherein the computing element extracts identifying information from the message sent according to the first standard protocol to provide at least one of billing and authorization information.

10. The system according to claim 1, wherein the computing element queues a plurality of messages prior to sending the plurality of messages.

11. A computing element operable to receive a message formatted according to a first standard protocol for over-the-air transmissions and to reformat the message to a format of a second standard protocol for over-the-air transmissions, said second standard protocol comprising a broadcast protocol operable to send the reformatted message to a plurality of receiving subscriber units at one time, said computing element comprising:
a data extractor to isolate message data, an origination address and a destination address; and
a packaging element operable to reformat the message data according to the second standard protocol.

12. The computing element of claim 11 further comprising a connection port to interface with a location server; and a determination device to determine a geographic area for the over-the-air transmissions based on a result returned by said location server.

13. The computing element of claim 12, wherein the second standard protocol comprises delivery of unacknowledged data packets.

14. The computing element of claim 11, further comprising an authorization determining element receiving the origination address and comparing the source address with a database to determine whether the computing element will reformat the message according to the second protocol for transmission.

15. The computing element of claim 11, wherein said data extractor further includes a data length determining device for determining a length of message data, and said packaging element further includes a message queue to store at least first and second messages of the second standard protocol when the length of the message data exceeds a predetermined length, said first and second messages each containing a portion of said message data.

16. The computing element of claim 15 wherein said data length determining device determines the length of the message data according to a data length indicator in the message of the first standard protocol.

17. The computing element of claim 16, wherein the first standard protocol comprises MO-SMS in a GSM system, and wherein the second standard protocol comprises cell broadcast CELL-B in the GSM system.

18. The computing element according to claim 11, further comprising a message filter, said message filter receiving at least one of the origination address and the destination address to determine a logical channel in which the reformatted message will be broadcast.

19. A method of providing a multi-user messaging service in a cellular network comprising:
receiving a message transmitted according to a first standard protocol for over-the-air transmissions; and
reformatting the message of the first standard protocol to a format of a second standard protocol for over-the-air transmissions, said second standard protocol comprising a broadcast protocol.

20. The method of claim 19, further comprising determining one or more cells for the over-the-air transmissions.

21. The method of claim 20, wherein the second standard protocol comprises delivery of unacknowledged data packets.

22. The method of claim 19 further comprising: extracting message data, a source address and a destination address from the message of the first standard protocol, and wherein the reformatting of the message comprises adding framing bits to the message data according to the second standard protocol.

23. The method of claim 22 further comprising determining a length of the message data wherein said reformatting of the message comprises creating at least a first and a second message in the second standard protocol, each of the first and second messages conveying a portion of the message data when the length of the message exceeds a predetermined length.

24. The method of claim 23, wherein said determining of the length of the message comprises extracting a data length indicator from the message of the first standard protocol to determine the length of the message data.

25. The method of claim 24, wherein the first standard protocol comprises MO-SMS in a GSM system, and wherein the second standard protocol comprises cell broadcast CELL-B in the GSM system.

26. The method claim 22 further comprising filtering the message according to at least one of the source and the destination address contained in said message to determine a logical channel in which the reformatted message will be broadcast.

27. The method of claim 19, further comprising extracting identifying information from the message sent according to the first standard protocol to provide at least one of billing and authorization information.

28. The method according to claim 19, further comprising queuing a plurality of messages prior to forwarding the plurality of messages to the transmission unit.

29. The system of claim 8, further comprising a location server and wherein the computing element determines one or more cells for broadcast using said second standard protocol based on a location result for one of the plurality mobile subscriber units originating a message, said location result being provided by the location server.

30. The system of claim 29, wherein the determined cell corresponds to a cell in which the originating mobile subscriber unit is located.

31. The system of claim 29, wherein the determined cells correspond to all cells in a mobile subscriber network.

32. The computing element of claim 18 further including a connection port to interface with a location server; and a determination device to determine one or more cells for the over-the-air transmissions based on a result returned by said location server.

33. The computing element of claim 32, wherein the determined cell corresponds to a cell in which a mobile subscriber unit corresponding to the extracted origination address is located.

34. The system of claim 32, wherein the determined cells correspond to all cells in a mobile subscriber network.

35. The method of claim 26, further comprising determining one or more cells for the over-the-air transmissions.

36. The method of claim 35, wherein the determined cell corresponds to a cell in which an originating mobile subscriber unit which originated the message according to the first standard protocol is located.

37. The method of claim 35, wherein the determined cells correspond to all cells in a mobile subscriber network.

38. The cellular communication system of claim 1, wherein said second broadcast protocol comprises an over-the-air broadcast to a plurality of subscribers simultaneously.

39. The method of claim 19, wherein said second standard protocol comprises an over-the-air broadcast to a plurality of subscribers simultaneously.

40. An article of manufacture comprising a computer readable medium including:
a computer program means for receiving a message transmitted according to a first standard protocol of over-the-air transmissions; and
a computer program means for reformatting the message of the first standard protocol to a format of a second standard protocol for over-the-air transmissions, said second standard protocol comprising a broadcast protocol.

41. The article of manufacture according to claim 40, wherein said second standard protocol comprises an over-the-air broadcast to a plurality of subscribers simultaneously.

42. The method according to claim 19 further comprising:
transmitting the reformatted message to a plurality of receiving subscriber units using the second standard protocol.
